(19) United States
(12) Patent Application Publication
(10) Pub. No.: US 2026/0057714 A1
(43) Pub. Date: Feb. 26, 2026

(54) SYSTEMS AND METHODS FOR INTEGRATED DIAGNOSTICS AND PROGNOSTICS OF A MULTICOMPONENT DYNAMIC SYSTEM

(71) Applicant: Ford Global Technologies, LLC, Dearborn, MI (US)

(72) Inventors: Amirhassan Abbasi, Farmington, MI (US); Matt Black, Manchester, MI (US); Arianna Duraku, Shelby Township, MI (US); Satheesh Kumar Chandran, Livonia, MI (US); Vicky Svidenko, Newcastle, WA (US)

(73) Assignee: Ford Global Technologies, LLC, Dearborn, MI (US)

(21) Appl. No.: 18/815,063

(22) Filed: Aug. 26, 2024

(51) Int. Cl. G07C 5/08; G07C 5/00

(52) U.S. Cl. CPC G07C 5/0816; G07C 5/006; G07C 5/0808

(57) ABSTRACT

A vehicle that can perform component-level diagnostics of its various systems, is disclosed. The vehicle includes processors, memory, a communication interface, and one or more sensors. The vehicle may receive vibration data related to a multicomponent dynamic system from the one or more sensors. The vehicle may also determine that a set of operating conditions associated with the multicomponent dynamic system is satisfied and determine health indication data for the multicomponent dynamic system. Based on the health indication data for the multicomponent dynamic system the vehicle can determine that the system is exhibiting unexpected behavior. Further, the vehicle may also determine that a second set of operating conditions associated with a component of the multicomponent dynamic system are satisfied and determine second health indication data for the component. Based on second health indication data, the vehicle may determine that the component is contributing to the unexpected behavior of the system.

### FIELD

The present disclosure relates to the field of detecting potential unexpected condition of components in a vehicle's multicomponent dynamic system.

### BACKGROUND

There are instances where it is difficult to determine root cause of a system or subsystem malfunction in a vehicle. Vehicles are complex pieces of machinery often having thousands of components and hundreds of systems and subsystems that have multiple components attached or coupled together that work in conjunction with each other. When a particular system or subsystem is experiencing unexpected behavior, high dimensionality, complexity and nonlinearity of interactions between components limit the capability of pin pointing which component of that system or subsystem is contributing to that unexpected behavior.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a block diagram of a vehicle according to an embodiment of the present disclosure.

FIG. 2 illustrates a block diagram of a server according to an embodiment of the present disclosure.

FIG. 3 illustrates process for determining health indication data for a multicomponent dynamic system according to an embodiment of the present disclosure.

FIG. 4 illustrates a process for determining individual components of a multicomponent dynamic system that may be the source of issue according to an embodiment of the present disclosure.

FIG. 5 illustrates two methods for determining the baseline or defect-free modal characteristics profile of individual components according to an embodiment of the present disclosure.

FIG. 6 illustrates a method for determining health indication data for individual components of a multicomponent dynamic system according to an embodiment of the present disclosure.

FIG. 7 illustrates a flow chart of a process for determining health of a component in real time according to an embodiment of the present disclosure.

### DETAILED DESCRIPTION

### Overview

The present disclosure describes systems and methods for determining which component within a multicomponent dynamic system of a vehicle may be the root cause of the unexpected functioning of that particular system.

In some instances, a method of identifying a component in a vehicle that may exhibit unexpected behavior is provided. The method may include the vehicle receiving vibration data associated with a multicomponent dynamic system of the vehicle. Thereafter, the vehicle determines that a first set of operating conditions associated with the multicomponent dynamic system have been satisfied. After that determination, the vehicle may determine first health indication data associated with the multicomponent dynamic system based on the vibration data. Next, the vehicle may determine that the multicomponent dynamic system is exhibiting unexpected behavior based on the first health indication data. The method further includes the vehicle determining that a second set of operating conditions associated with a first component of the multicomponent dynamic system have been satisfied. Based on that, the vehicle further determines second health indication data associated with the first component based on the vibration data. Thereafter, the method may include determining, using the second health indication data, that the first component is exhibiting unexpected behavior and outputting information about the first component by the vehicle.

In some instances, a vehicle having one or more processors, one or more memories coupled to the one or more processors, a communication interface coupled to the one or more processors, and one or more sensors coupled to the one or more processors is provided. The vehicles may receive, from the one or more sensors, vibration data associated with a multicomponent dynamic system of the vehicle and also determine that a first set of operating conditions associated with the multicomponent dynamic system have been satisfied. Responsive to first set of operating conditions being satisfied the vehicle may determine first health indication data associated with the multicomponent dynamic system and thereafter determine that the multicomponent dynamic system is exhibiting unexpected behavior, based on the first health indication data. The vehicle may then determine that a second set of operating conditions associated with a first component of the multicomponent dynamic system have been satisfied and responsive to the second set of operating conditions being satisfied and based on the vibration data, the vehicle may determine second health indication data associated with the first component. Thereafter, the vehicle may determine that the first component is exhibiting unexpected behavior, based on the second health indication data and output information about the first component.

In yet another instance, a vehicle having one or more processors, one or more sensors coupled to the one or more processors, and a system having a plurality of mechanical components is provided. The vehicle may receive vibration data associated with the system from the one or more sensors and also determine that a first of operating conditions associated with the system are satisfied. Based on that the vehicle may determine first health indication data associated with the system, wherein the first health indication data is based on global data associated with the system. Further, the vehicle may determine, based on the first health indication data, that the system is exhibiting unexpected behavior and responsive to determining that the system is exhibiting unexpected behavior, the vehicle may determine that a second set of operating conditions associated with a first component of the plurality of components are satisfied. Thereafter, the vehicle may further determine second health indication data associated with the first component and based on the second health indication data, determine that the first component is exhibiting unexpected behavior and output information about the first component.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

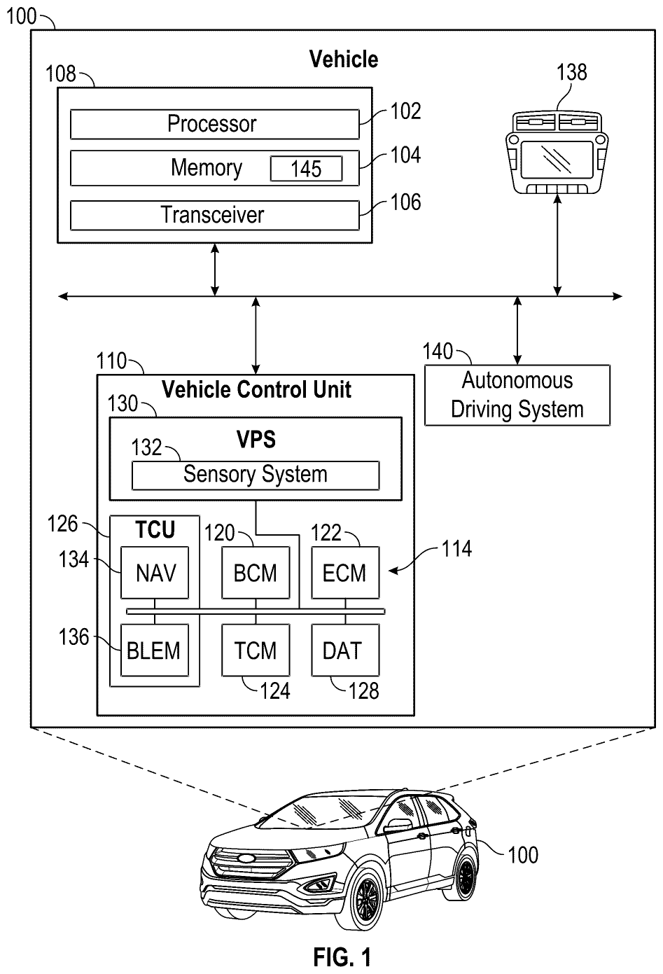

FIG. 1 illustrates a block diagram of a vehicle 100 in which embodiment of the present disclosure can be implemented. The vehicle 100 may include a plurality of units including, but not limited to, an automotive computer 108, a Vehicle Control Unit (VCU) 110, and an infotainment unit 138. The VCU 110 may include a plurality of Electronic Control Units (ECUs) 114 disposed in communication with the automotive computer 108.

In some embodiments, a user device, such as a mobile phone, a laptop computer, or the like may be configured to connect with the automotive computer 108, which may communicate via one or more wireless connection(s), and/or may connect with the vehicle 100 directly by using near field communication (NFC) protocols, Bluetooth® protocols, Wi-Fi, Ultra-wideband (UWB), and other possible data connection and sharing techniques.

The automotive computer 108 may be installed anywhere in the vehicle 100, in accordance with the disclosure. The automotive computer 108 may be or include an electronic vehicle controller, having one or more processor(s) 102, one more memories 104, and one or more transceivers 106.

The processor(s) 102 may be disposed in communication with one or more memory devices disposed in communication with the respective computing systems (e.g., the memory 104 and/or one or more external databases not shown in FIG. 1). The processor(s) 102 may utilize the memory 104 to store programs in code and/or to store data for performing operations in accordance with the disclosure. The memory 104 may be a non-transitory computer-readable storage medium or memory storing a vehicle control program code. The memory 104 may include any one or a combination of volatile memory elements (e.g., dynamic random access memory (DRAM), synchronous dynamic random access memory (SDRAM), etc.) and may include any one or more nonvolatile memory elements (e.g., erasable programmable read only memory (EPROM), flash memory, electronically erasable programmable read only memory (EEPROM), programmable read only memory (PROM), etc.). In some embodiments, memory 104 may include a module 145 that can implement the various embodiments of the present disclosure. Module 145 may include instructions that can be executed by the processor 102 to realize the various embodiments of the present disclosure.

Automotive computer 108 may also include a transceiver 106. The transceiver 106 may be configured to receive information/inputs from one or more external devices or systems, e.g., a user device 108, an external server, and/or the like. Further, the transceiver 106 may transmit notifications, requests, signals, etc. to the external devices or systems. In addition, the transceiver 106 may be configured to receive information/inputs from vehicle components such as the vehicle sensory system 132, one or more ECUs 114, and/or the like. Further, the transceiver 106 may transmit signals (e.g., command signals) or notifications to the vehicle components such as the BCM 120, the infotainment system 138, or send the information directly to the cloud and/or the like.

In some embodiments, the VCU 110 may share a power bus with the automotive computer 108 and may be configured and/or programmed to coordinate the data between vehicle systems, connected servers and/or the like. The VCU 110 may include or communicate with any combination of the ECUs 114, such as, for example, a Body Control Module (BCM) 120, an Engine Control Module (ECM) 122, a Transmission Control Module (TCM) 124, a Telematics Control Unit (TCU) 126, a Driver Assistances Technologies (DAT) controller 128, etc. The VCU 110 may further include and/or communicate with a Vehicle Perception System (VPS) 130, having connectivity with and/or control of one or more vehicle sensory system(s) 132. The vehicle sensory system 132 may include one or more vehicle sensors including, but not limited to, a Radio Detection and Ranging (RADAR or “radar”) sensor configured for detection and localization of objects inside and outside the vehicle 100 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 132 may be coupled to the vehicle 100 at one or more locations and in one or more manner. For example, the various sensors of the vehicle sensory system 132 may be integrated into the various subsystems of the vehicle 100, such as doors, mirrors, roof, etc. or attached to the vehicle 100 using an appropriate mounting mechanism. In some embodiments, the various sensors of the vehicle sensory system 132 may be located at the front, back, sides, top, bottom, and underneath the vehicle 100. The location of a sensor may depend on its function. For example, a sensor that monitors the area underneath the vehicle may be connected to a bottom surface of the vehicle 100 while a sensor that can monitor an area to either side of the vehicle 100 may be mounted or integrated into the doors of the vehicle 100. Vehicle sensory system 132 may also include one or more road noise sensors such as accelerometers that are coupled to various mechanical components and/or systems of the vehicle 100. One skilled in the art will realize that the sensors may be coupled to the vehicles in various different ways and locations other than the ones mentioned above.

In some embodiments, the VCU 110 may control vehicle operational aspects and implement one or more instruction sets received from the transceiver 106 the user device 108 or from one or more instruction sets stored in the memory 104.

The TCU 126 may be configured and/or programmed to provide vehicle connectivity to wireless computing systems onboard and off board the vehicle 100, and may include a Navigation (NAV) receiver 134 for receiving and processing a GPS signal, a BLE® Module (BLEM) 136, a Wi-Fi transceiver, a UWB transceiver, and/or other wireless transceivers (not shown in FIG. 1) that may be configurable for wireless communication (including cellular communication) between the vehicle 100 and other systems (e.g., a vehicle key fob (not shown in FIG. 1), an external server, a user device, etc.), computers, and modules. The TCU 126 may be in communication with the ECUs 114 by way of a bus. In some aspects, the TCU 126 may be configured to determine a real time vehicle geolocation, e.g., via the NAV receiver 134.

The ECUs 114 may control aspects of vehicle operation and communication using inputs from human drivers, inputs from the automotive computer 108, and/or via wireless signal inputs received via the wireless connection(s) from other connected devices.

The BCM 120 generally includes integration of sensors, vehicle performance indicators, and variable reactors associated with vehicle systems, and may include processor based power distribution circuitry that may control functions associated with the vehicle body such as lights, windows, security, camera(s), audio system(s), speakers, wipers, door locks and access control, various comfort controls, etc. The BCM 120 may also operate as a gateway for bus and network interfaces to interact with remote ECUs (not shown in FIG. 1).

The DAT controller 128 may provide Level-1 through Level-3 automated driving and driver assistance functionality that may include, for example, active parking assistance, vehicle backup assistance, and/or adaptive cruise control, among other features. The DAT controller 128 may also provide aspects of user and environmental inputs usable for user authentication.

In some embodiments, the automotive computer 108 may connect with an infotainment system 138 (or a vehicle Human-Machine Interface (HMI)). The infotainment system 138 may include a touchscreen interface portion, and may include voice recognition features, biometric identification capabilities that may identify users based on facial recognition, voice recognition, fingerprint identification, or other biological identification means. In other aspects, the infotainment system 138 may be further configured to receive user instructions via the touchscreen interface portion, and/or output or display notifications, navigation maps, etc. on the touchscreen interface portion.

The computing system architecture of the automotive computer 108 and/or the VCU 110 may omit certain computing modules. It should be readily understood that the computing environment depicted in FIG. 1 is an example of a possible implementation according to the present disclosure, and thus, it should not be considered as limiting or exclusive.

In some embodiments, vehicle 100 may include an autonomous driving system 140. Vehicle 100 may be manually driven or configured to operate, using the autonomous driving system 140, in a fully autonomous (e.g., driverless) mode (e.g., Level-5 autonomy) or in one or more partial autonomous modes which may include driver assist technologies. Examples of partial autonomous (or driver assist) modes are widely understood in the art as autonomy Levels 1 through 4. For example, a vehicle having Level-1 autonomy may include a single automated driver assistance feature, such as steering or acceleration assistance. Adaptive cruise control is one such example of a Level-1 autonomous system that includes aspects of both acceleration and steering.

Level-2 autonomy in vehicles may provide driver assist technologies such as partial automation of steering and acceleration functionality, where the automated system(s) are supervised by a human driver who performs non-automated operations such as braking and other controls. In some embodiments, with Level-2 autonomous features and greater, a primary user may control the vehicle while the user is inside of the vehicle, or in some example embodiments, from a location remote from the vehicle but within a control zone extending up to several meters from the vehicle while it is in remote operation.

Level-3 autonomy in a vehicle can provide conditional automation and control of driving features. For example, Level-3 vehicle autonomy may include “environmental detection” capabilities, where the autonomous vehicle (AV) can make informed decisions independently from a present driver, such as accelerating past a slow-moving vehicle, while the present driver remains ready to retake control of the vehicle if the system is unable to execute the task.

Level-4 AVs can operate independently from a human driver, but may still include human controls for override operation. Level-4 automation may also enable a self-driving mode to intervene responsive to a predefined conditional trigger, such as a road hazard or a system event.

Level-5 AVs may include fully autonomous vehicle systems that require no human input for operation and may not include human operational driving controls.

In addition to the components noted above, the vehicle 100 may have numerous mechanical systems and subsystems. A chassis or frame may form the backbone of the vehicle 100 and support the body and other components of the vehicle 100. The vehicle 100 may include an engine that converts fuel into mechanical power, propelling the vehicle forward. The engine includes various components such as the engine block, pistons, valves, and spark plugs. The vehicle 100 also includes a transmission system. The transmission system transfers the engine's power to the wheels. It includes the clutch, gearbox, driveshaft, and differentials, among other components. The transmission adjusts the power output to suit the vehicle's speed and load. The vehicle 100 may also include a suspension system. The suspension system absorbs shocks and maintains contact between the tires and the road, providing a smooth ride. It includes components such as springs, shock absorbers, and linkages. The vehicle 100 also includes a braking system that allows the driver to slow down or stop the vehicle 100. It includes components like brake pedals, master cylinder, brake lines, and brake pads or shoes. The vehicle 100 also includes a steering system that enables the driver to guide the car. The steering system includes components such as the steering wheel, steering column, rack and pinion, and tie rods. The vehicle 100 also includes an exhaust system that removes and filters the waste gases produced by the engine. It includes the exhaust manifold, catalytic converter, muffler, and tailpipe, among other components. The vehicle 100 also includes a cooling system that prevents the engine from overheating. It includes components such as the radiator, water pump, thermostat, and coolant. The vehicle 100 also includes a cooling system that stores and supplies fuel to the engine. It includes the fuel tank, fuel pump, fuel filter, and fuel injectors. An electrical system of the vehicle 100 powers the car's electrical components. It includes the battery, alternator, starter motor, and wiring. The Heating, Ventilation, and Air Conditioning (HVAC) system regulates the temperature inside the vehicle 100. It includes the heater core, blower motor, and air conditioning compressor. All of the mechanical components working together ensure that the vehicle operates smoothly.

During operation, the vehicle 100 is subject to the road conditions and may experience vibration. The vibration experienced by the vehicle 100 is more pronounced for components that are located at the underside of the vehicle 100. Such systems and components are commonly referred to as “underbody components” or “underbody systems.” These underbody components may include but are not limited to stabilizer bar, shock absorbers, dust shield, steering gear, tie rod, control arm, and the wheel bearing/hub. The vibrations experienced by these underbody components affects their performance over the life of the vehicle 100. For example, some components may become loose due to the vibrations and/or develop a mechanical or structural issue over time. It is beneficial to monitor these components continually and detect any deviations from the normal operation and/or predict potential issues with specific components based on their current state. One way to do this is via physical inspection of these components. However, physical inspections are expensive and time consuming and users often to not take their vehicle for inspection unless there is some issue with the vehicle. In addition, even physical inspection may not catch all the potential issues for all of these various components. Embodiments of the present disclosure provide systems and methods for continually monitoring such components and alert the user of a future potential issue with a component before that issue actually occurs.

Modal characteristics are useful in understanding the behavior of mechanical components under different conditions. They are particularly useful in the field of vibration analysis, where they help in predicting the response of a system or a component to various inputs. The natural frequency is the frequency at which a system oscillates when not subjected to a continuous or unbalanced external force. Each mechanical component has one or more natural frequencies. The mode shape describes the pattern of the deformation that a component undergoes at its natural frequency. Damping is the phenomenon that causes a vibrating system to lose energy over time. It's an important characteristic as it affects how quickly the system returns to equilibrium. In mechanical components, damping can occur due to internal friction, air resistance, or energy dissipation through the material. Resonance occurs when the frequency of an externally applied force matches a natural frequency of the system. This can lead to large oscillations and potential unexpected behavior of the system or component. Understanding the modal characteristics of a system or component can help engineers design to mitigate resonance. Modal analysis is a process that can be used to determine the modal characteristics of a mechanical component. It involves exciting the component at various frequencies and measuring the response. This information can be used to create a mathematical model of the component that predicts how it will behave under different conditions. Understanding the modal characteristics of mechanical components is beneficial in both the design and maintenance phases. In the design phase, it allows designers to predict how a component will behave under different operating conditions of the vehicle and to make necessary adjustments to mitigate issues such as resonance. During maintenance of the vehicle, changes detected in the modal characteristics can indicate issues such as material degradation.

Vibration analysis is useful tool for predictive maintenance for mechanical components. It involves the measurement, analysis, and interpretation of the oscillations produced by systems and components. The first step in vibration analysis is to measure the vibrations produced by a component. This is typically done using sensors such as accelerometers, which can measure the acceleration of component's vibrations. The raw vibration data is a complex signal that contains a mixture of different frequencies. The vibration data after conditioning/filtering is transformed into the frequency domain using a mathematical technique called Fourier Transform. This transformation yields the individual frequencies that make up the overall vibration. Thereafter, the natural frequencies, damping factors, and mode shapes of the system are identified. The natural frequencies are at which the system naturally tends to vibrate. Each mode shape represents the deformation pattern of the system at the corresponding natural frequency. By comparing the measured vibration signature with known signatures of various faults or baseline defect-free condition, it is possible to diagnose specific issues.

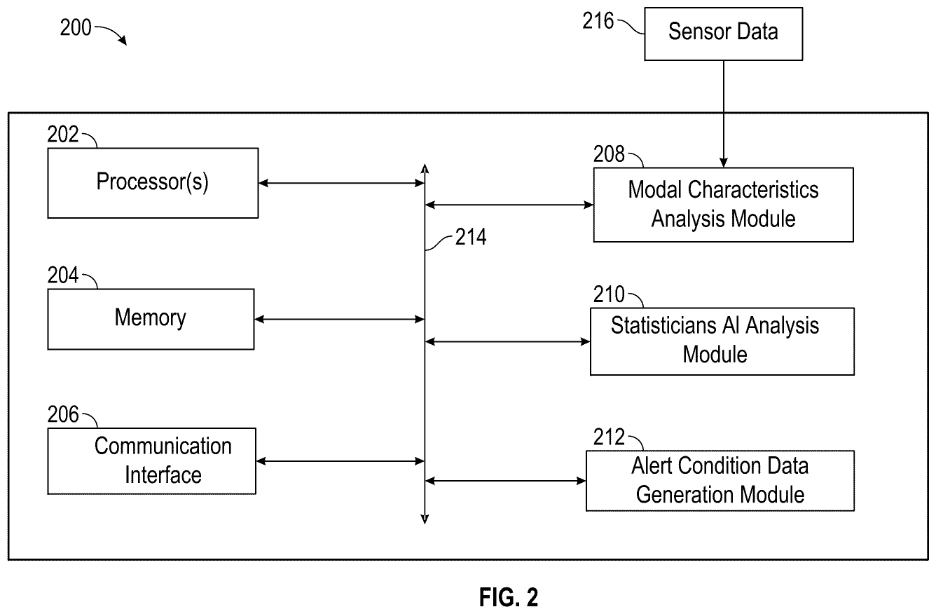

FIG. 2 illustrates another environment in which some embodiments of the present disclosure may be implemented. The environment may include one or more servers 200 that are separate from the vehicle 100. In some instances, the vehicle 100 may work in conjunction with the server(s) 200 to implement the various embodiments of the present disclosure. The server 200 may include one or more processors 202, one or more memories 204, a communication interface 206, a modal characteristic analysis module 208, a statistical analysis module 210, and an alert condition data generation module 212.

The server 200 includes one or more hardware processors 202. The hardware processor 200 may be a central processing unit (CPU). The hardware processor 202 may perform most of the processing inside the server 200. It interprets and executes instructions and data from other hardware components and software modules. The one or more memories 204 may include short-term memory such as a Random Access Memory (RAM) or long-term memory such as hard drives or solid state drives. RAM is the server's short-term memory where it stores data that is being used or processed by the CPU. The memory 204 may also store the server operating system and one or more instructions that when executed by the processor(s) 202 cause the server 200 to perform one or more specialized functions described below such as modal characteristics determination, statistical analysis, etc. The communication interface 206 may include hardware and firmware that enables the server 200 to communicate with external systems such as the vehicle 100 or other servers in a networked environment. The communication interface 206 may utilize any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the communication interface 206 may include one or more physical jacks (e.g., Ethernet, coaxial, or phone jacks) or one or more antennas to communicate with external systems. In an example, the communication interface 206 may include a plurality of antennas to wirelessly communicate using at least one of single-input multiple-output (SIMO), multiple-input multiple-output (MIMO), or multiple-input single-output (MISO) techniques.

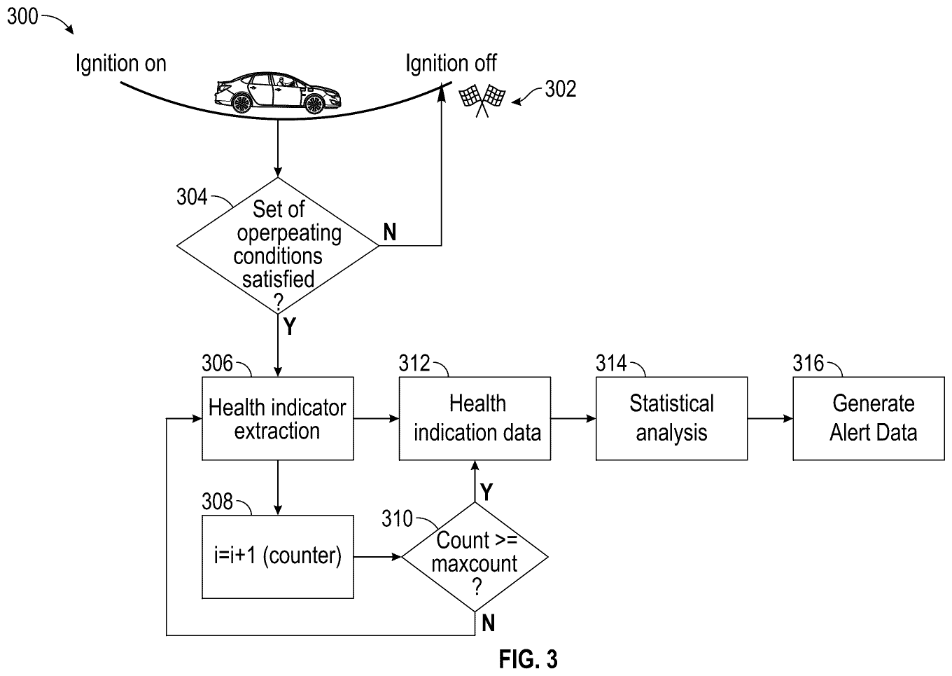

The modal characteristics analysis module 208 may include instructions that when executed by the processor 202 cause the server to receive sensor data 216 and use that sensor data to determine the modal characteristics of the associated systems and components. The details of determining the modal characteristics are provided below with reference to FIGS. 3-7. The statistical analysis module 210 takes the data generated by the modal characteristics analysis module 208 and determines trends for various components of a vehicle. The alert condition data generation module 212 generates various alerts and notifications based on the modal characteristics of the various components. These alters and notifications may be provided to the user of the vehicle, e.g., via the infotainment system 138 or via a user device such as a mobile phone, tablet, PC, etc. The server 200 also include a communication link 214, such as a bus, that acts as a common communication channel between all the components of the server 200. The communication link 214 can be any known communication medium in the art. In some embodiments, the modal characteristic analysis module 208, the statistical analysis module 210, and the alert condition data generation module 212 may be implemented in the vehicle 100 of FIG. 1.

In order to understand potential issues with a multicomponent dynamic system or a component, the first step is to perform a system-level baselining of a multicomponent dynamic system and/or the individual component. FIG. 3 illustrates a process 300 for performing the baselining at a system level and at a component level for a vehicle (e.g., the vehicle 100) according to an embodiment of the present disclosure. After a vehicle is manufactured and cleared from the factory after the requisite quality checks, the vehicle is considered to be in a defect-free condition. Over time, as the vehicle is used by the owner, the mechanical components of the vehicle experience normal wear and tear. In order to understand how a particular system or component will behave under certain conditions, it is important to baseline the system during this defect-free condition of the vehicle. Further, each system or component of the vehicle is influenced differently by certain operating conditions of the vehicle. For example, a suspension system of a vehicle may be most affected by the speed of the vehicle, the steering angle, and/or the acceleration of the vehicle. Similarly, other components or systems of the vehicle may be most influenced by other operating conditions of the vehicle. Some examples of the operating conditions of the vehicle include, but are not limited to speed, acceleration and brake torque, steering angle, gross train weight of the vehicle, tire pressure, ambient temperature, etc. It is to be noted that the above list is not exhaustive and is merely exemplary. One skilled in the art will understand that there are many more operating conditions of the vehicle that affect the performance of the mechanical components of the vehicle.

In order to gather the vibration data of the various systems, a plurality of sensors, such as accelerometers are placed at various locations in the vehicle. For ease of explanation, we will use the underbody system and components to explain the various embodiments of the present disclosure. However, it is to be noted that the systems and methods provided in this disclosure are equally applicable to other systems and components of a vehicle. In one embodiment, a plurality of accelerometers may be placed at various locations within or along the underbody of the vehicle. In some embodiments, the accelerometers may be 3-axis accelerometers. As the vehicle is operated, each of these accelerometers measure the acceleration along each of the 3-axes and provide that data continually, e.g., to the server 200 or to the automotive computer 108. The operation of the vehicle is determined as being from ignition ‘on’ to ignition ‘off’ (also called a “trip” or a full power cycle), as illustrated in step 302. In one example, the vehicle may be driven from point A to point B and the accelerometer measurements are taken while the vehicle is in motion from point A to point B.

As mentioned above, each system and component of the vehicle is influenced to varying degrees by certain operating conditions of the vehicle. In our underbody system example, operating conditions such as speed, acceleration, steering angle, etc. may have the most influence on the underbody system. Further, for each of these operating conditions, there may be a certain range of values for each of the operating conditions that may be the most influential for the underbody system. For example, the speed range of between 10 mph and 80 mph and/or a steering angle of between 20 degrees and 30 degrees on either side may be most influential on the underbody system. During the operation of the vehicle, it is determined whether the set of operating conditions associated with the underbody system are met (step 304). If the operating conditions are not met, the process 300 returns to step 302 and keeps checking for the operating conditions. In one embodiment, the data about the operating conditions is received from the Controller Area Network (CAN bus) of the vehicle. The CAN bus is well known in the art and hence further explanation of the CAN bus is not provided herein for sake of brevity.

As noted above, the various sensors, (e.g., accelerometers) are continually collecting data as the vehicle is being driven. In one embodiment, this data may be continually stored in a rolling buffer and new data may overwrite old data periodically until the set of operating conditions are met at step 304. In one embodiment, the data from the sensors may be communicated over an Automotive Audio Bus (A2B) of the vehicle. The A2B technology is well known in the art. If at step 304, it is determined that the set of operating conditions for the particular underbody system is met, the sensor data is analyzed to extract one or more health indicators for the underbody system at step 306. The health indication data 312 may include root mean square (RMS) of the vibration data, mean of the vibration data, etc. In order to make a comprehensive baselining, a minimum number of samples of the vibration data is collected. The number of samples of the vibration data collected is controlled by a counter at step 308. After a first sample of the vibration data is collected and the associated health indication data 312 is determined, the counter is incremented by 1 at step 308. Thereafter, at step 310, the counter value is checked to determine whether the current value of the counter is greater than or equal to a threshold count value. The threshold count value can be set based on the number of samples of data that may be desired to be collected. Further, this threshold count value may be different for different systems or components of the vehicle.

If the current counter value is less than the threshold counter value at step 310, the process returns to step 306 to determine the next sample of the health indication data. It is to be noted that this is done provided the set of operating conditions continue to be met. Once it is determined at step 310 that the current counter value is equal to or greater than the threshold counter value, all the samples of the health indication data 312 are then analyzed to determine the statistical distribution of the health indication data at step 314. In some embodiments, the set of operating conditions may be met multiple times during each trip. For example, in a 10 min trip, the set of operating conditions may be met three times and each of those times may be of different durations or windows of time. In the first instance, the set of operating conditions may be met for 50 secs. In the second instance the set of operating conditions may be met for 1 min and in the third instance the set of operating conditions may be met for 20 secs. During each of these durations (50 secs, 1 min, and 20 secs), the accelerometer data is continually collected. However, only the most recent data from each of these time durations may be used to the statistical analysis. The statistical distribution of the health indication data 312 provides information about the defect-free profile of the underbody system of the vehicle.

In order to ensure that the defect-free profile generated by process 300 is as robust as possible, it is beneficial to reduce the noise data in the system. By tying the data collection to the presence of the specific vehicle operating conditions (step 304), the noise in the system is kept to a minimum. Certain operating conditions of the vehicle may introduce more noise in the system. For example, sudden increase in speed or slow down, aggressive steering, etc. may produce data that has sufficient noise in it so as to impede with a robust defect-free profile determination. By limiting the operating conditions to a carefully chosen range, the effects of noise can be mitigated. For example, during a sudden increase or decrease in speed of the vehicle, application of external force to the wheel and/or hub assembly may adversely affect the information content of vibration data. Hence it may not be ideal to use the vibration data collected during such an event.

As part of the statistical analysis, the health indication data 312 may be down-sampled, subjected to noise removal, processed using a band-pass filter and then transformed from the time domain to the frequency domain, e.g., using Fourier Transform techniques. Thereafter a set of features may be extracted from the health indication data. Further, the health indication data 312 may yield a frequency distribution data that indicates, e.g., the resonant frequency of the under body system. At step 316, a set of alert conditions may be determined based on the defect-free profile of the vehicle. The alert conditions may include information that is used to compare the real time health indication data of the vehicle once the vehicle is delivered to the consumer and he/she starts using the vehicle. In one example, the alert condition may be the mean of the vibration data +/_ three standard deviation. So, whenever the vibration signature of the vehicle falls outside the mean +/_ three standard deviation, an alert may be provided to the user via the vehicle or a user device indicating potential issue with the underbody system.

The defect-free profile at the system-level is determined as explained above. When the vehicle is being operated by a user, real time vibration data for the under body system can be measured using the sensors. This real time data may be compared to the defect-free profile data to determine any potential issue with the underbody system. However, in order to have a more granular determination of the source of the potential issue, it is beneficial to determine which specific component or components of the system are responsible for the unexpected operation of the system. In order to accomplish that, the data measured at the system-level may be correlated to the components of that system in order to determine which specific component(s) could be the source of the issue within the under body system.

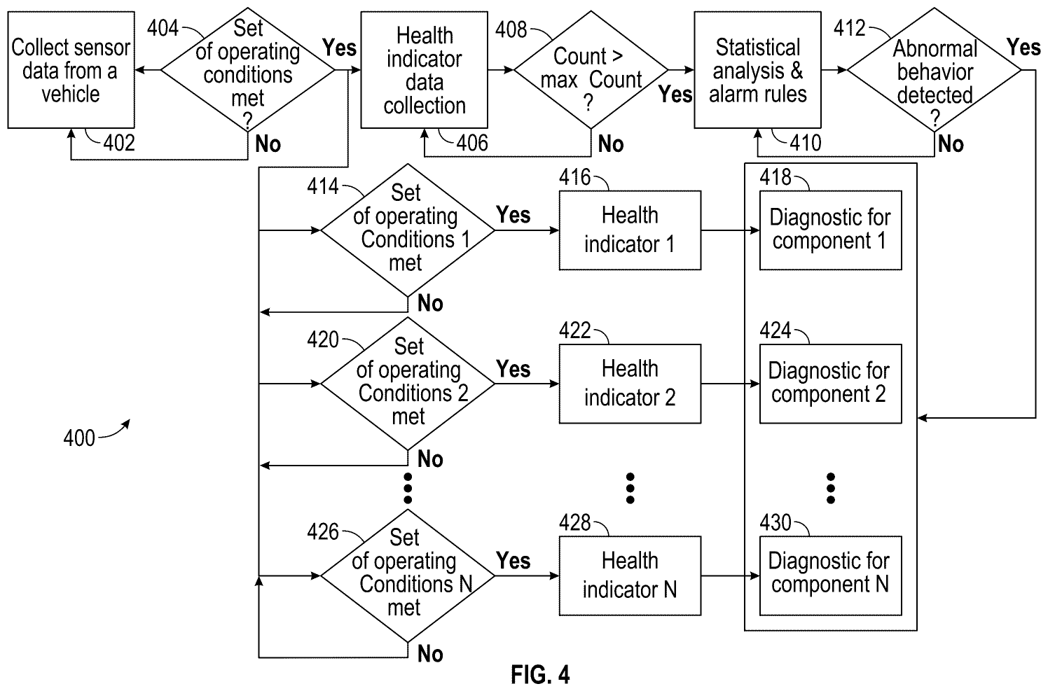

FIG. 4 illustrates a process 400 for determining individual components of a multicomponent dynamic system that may be the source of issue according to an embodiment of the present disclosure. The process 400 may be performed in real-time as the vehicle 100 is operated by a user. Similar to a multicomponent dynamic system, each component of that system is also affected differently based on the operating conditions of the vehicle. In other words, each component of the vehicle has its own set of operating conditions that may influence the component the most. For example, a stabilizer bar that is part of the suspension system of the vehicle may be under more load when the vehicle is subjected to roll and any unexpected behavior of the stabilizer bar is likely to be manifested within certain rolling involved events such as cornering. The cornering events can be characterized by vehicle information such as acceleration and steering angle. Therefore, specific ranges of acceleration and steering angle of the vehicle may be the operating condition under which the health data for the stabilizer is most relevant and informative. At step 402, vibration data from one or more accelerators of the vehicle, e.g., vehicle 100 of FIG. 1, is collected. Step 402 may be similar to step 302 of FIG. 3. At step 404, it is determined whether a set of operating conditions is met. These set of operating conditions may include operating conditions for the system as well as operating conditions for each of the components within the system. As a first check, the system level health indication data is determined at step 406. This is similar to the steps 306 and 312 of FIG. 3. The counter value is checked at step 408. If the counter value is greater than or equal to a threshold counter value, the collected vibration data from the sensors is analyzed at step 410 to generate a system-level profile of the vehicle. This real time system level profile of the vehicle is then compared to the defect-free system level profile that is pre-generated as explained with reference to FIG. 3 above (step 412). If it is determined at step 412 that there is unexpected operation of the multicomponent dynamic system, the process 400 proceeds to determine which specific component within the multicomponent dynamic system is most likely the source of the unexpected operation.

As explained above, each component of the multicomponent dynamic system may have its own set of operating conditions that affect the component the most. For example, assume that a multicomponent dynamic system of the vehicle has N number of individual components. In this instance, at step 414 it is determined whether a first set of operating conditions associated with a first component of the multicomponent dynamic system are satisfied. If it is determined that the first set of operating conditions are not satisfied, the process 400 moves on to step 420 and determines whether a second set of operating conditions associated with a second component of the multicomponent dynamic system are satisfied. If at step 420 it is determined that even the second set of conditions is not satisfied, the process 400 moves on to determining whether the next set of operating conditions is satisfied. This process may continue until the process 400 determines whether the N^{th} set of operating conditions are satisfied for the N^{th} component (step 426). If it is determined that none of the operating conditions for any of the components of the multicomponent dynamic system are satisfied, the process 400 may return to step 414 and the loop continues.

If it is determined that one or more of the N sets of operating conditions are satisfied, the health indication data for that particular component is extracted from the vibration data received from the vehicle at step 402. For example, if it is determined that the first set of operating conditions are satisfied, then at step 416 the health indication data for the first component is determined from the vibration data. Similarly, if the second set of operating conditions are met/satisfied, then at step 422 the health indication data for the second component is determined from the vibration data. Finally, if it is determined that the Nth set of operating conditions are satisfied, the health indication data for the Nth component is determined at step 428. Thereafter, the health indication data determined for each of the component is compared against the baseline data for that component to determine whether that particular component is operating outside of its normal or defect-free range. For example, the health indication data for the first component is compared to its baseline or defect-free profile at step 418, the health indication data for the second component is compared to its baseline or defect-free profile at step 424, and the health indication data for the Nth component is compared to its baseline or defect-free profile at step 430. Based on these comparisons, one or more components may be found to be operating outside of their defect-free profile. These components are then identified, e.g., using their part numbers, and a notification about these components may be outputted by the vehicle, e.g., via the infotainment system 138, or sent to a user device such as a mobile phone or tablet.

It is to be noted that process 400 is a two-step process in which first unexpected behavior at the system level is determined, e.g., at step 412. If the result of step 412 indicates that there is unexpected behavior of the system, only then the process 400 proceeds with steps 414, 420, 426, etc. If the result of the comparison in step 412 indicates no unexpected behavior of the system, the process 400 may return to step 410. Further, the set of operating conditions for each of the components used in steps 414, 420, and 426 is a subset of the operating conditions that are used in step 404 to determine system-level health indication data. In some embodiments, the “set” of operating conditions may include one or more operating conditions.

In some embodiments, the set of operating conditions for the one or more components of the multicomponent dynamic system may be met or satisfied multiple times. For example, the first set of operating conditions may be satisfied twice during a trip, for a duration of 5 secs and 10 secs respectively. The vibration data from the sensors is continually received by the vehicle. During these two time intervals, the vibration data is stored in a buffer. So, for the first duration, 5 secs of vibration data is stored and for the second duration, 10 secs of vibration data is stored. In both these instances, there may be multiple data points stored in the buffer. In one embodiment, the most current data point from each of the two durations is used to determine the health indication data. In other embodiments, a mean or an average of the data for each duration may be calculated and that mean or average may be used for determining the health indication data.

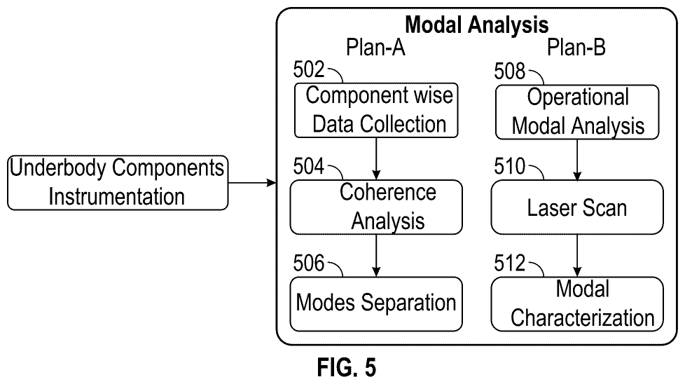

As explained above, during operation of the vehicle the vibration data is collected in real time and compared against the baseline data for each component. FIG. 5 illustrates two methods for determining the baseline or defect-free modal characteristics profile of individual components according to an embodiment of the present disclosure. Model characteristics of a component represent the physical properties that govern its interaction with other components and its response to forces in a multicomponent dynamic system. Natural frequencies are the frequencies at which a component naturally vibrates when excited, each associated with a unique mode shape. Mode shapes represent deformation patterns at these frequencies, showing how different points move relative to each other. Natural frequencies depend on the material properties, geometry, and boundary conditions. Damping ratios measure the rate of vibration decay. Modal mass is associated with the effective mass involved in a particular vibration mode, and modal stiffness describes the resistance to deformation in each mode. Modal characteristics are derived from the structure itself, making them suitable for component wise baselining and health indicator extraction, as well as reflecting the most common structural effects of damage (changes in mass, stiffness, and boundary conditions).

To determine modal characteristics of a component, it is beneficial to understand the local modes of that component. Local modes of a component refer to the specific vibrational modes that are predominantly localized to a particular part of a structure. These modes are often observed in complex structures composed of several different components with different structural properties. In the context of modal analysis, local modes may be present in a subset of Frequency Response Function (FRF) measurement locations. This is why a FRF summation based on all FRFs may not show a peak due to the local mode of a component. It is useful to analyze the FRFs based on individual components instead of all FRFs. In some embodiments, the peaks in the summation of an individual component can indicate the local modes of the component.

In order to determine the modal characteristics of individual components of a multicomponent dynamic system, the entire multicomponent dynamic system, such as a vehicle, may be subjected to broadband excitation. In an embodiment, the vehicle may be excited with a white noise excitation force within a certain frequency range. White noise is a random signal having equal intensity at different frequencies, giving it a constant power spectral density. The white noise contains all frequencies within the given range, making it a form of broadband excitation. In an embodiment, the frequency range used for the broadband excitation may be between 2 Hz and 10,000 Hz. The response of the vehicle to the broadband excitation can help identify resonant frequencies where the vehicle might vibrate excessively. When the vehicle is subjected to a broadband excitation, both the global modes and local modes may be activated. Global modes of a vehicle refer to the vibrational modes that involve the motion of the entire vehicle structure. Global modes are not very useful in determining the modal characteristics of individual components. FIG. 5 illustrates two methods of determining the local modes of each of the components in a multicomponent dynamic system.

In the first method, one or more sensors such as accelerometers are coupled to the components of the multicomponent dynamic being tested. The system and/or the vehicle is then subjected to a broadband excitation in an isolated environment under different loading conditions, to limit effects of noise. The vibration data from the accelerometers coupled to the various components may be captured at step 502. A wide range of frequencies may be used for the excitation in steps of, e.g., 3-4 Hz. Thereafter, cross coherence value determination may be made for each of the components of the multicomponent dynamic system for multiple frequencies. In some embodiments, for a given frequency range, most, if not all, the components may exhibit similar coherence values. In other embodiments, a component may show inconsistent coherence values compared to the other components for a particular frequency range. In that particular frequency range, it is likely that the local mode of that component may be active since that component is not following the vibration pattern of the rest of the components in the multicomponent dynamic system. The output of the coherence analysis at step 504 may provide a frequency at or a frequency range in which the local mode of a component may be active. This process may be repeated multiple times until a frequency or frequency range associated with the local mode of each component of the multicomponent dynamic system is identified. This frequency or frequency range may be then used to determine the health indicator of that particular component. Thereafter mode separation data may be generated at step 506. The mode separation data indicates the frequency or frequency range at which the local mode of each component may be likely to be active. This frequency information may be then used to determine the health indication data, e.g., at step 416 of FIG. 4.

In the second mode (steps 508, 510, and 512), the multicomponent dynamic system may be subjected to broadband excitation as explained above. In this method, there is no need to couple sensors to the various components of the multicomponent dynamic system. Instead, a laser is used to scan the surface of the multicomponent dynamic system and the individual components. This method is based on the Doppler Effect, which occurs when light is back-scattered from a vibrating surface. Both the velocity and displacement of the surface can be determined by analyzing the optical signals. In one embodiment, the laser beam sequentially scans the entire surface of the multicomponent dynamic system and/or the individual components using a range of single-point measurements. This results in transfer functions for each and every measurement location. The areal simultaneous motion sequence of the system or component under examination can be animated in the time domain. This enables isolation of the frequency ranges associated with the local mode of each component in the multicomponent dynamic system.

In one embodiment, the laser measures the vibration of the system or component joining together the spatial and time information. The natural frequencies and mode shape vectors for the individual components are determined from the vibration data. This processing can be done in time or frequency domain. The information about the resonance frequency for each component can then be used to determine the local and global modes and accordingly frequency neighborhood for which the health indication data is to be extracted. For example, consider that it is determined from the above method that the local mode of a particular component is about 50 Hz. In this instance, a frequency range is chosen, e.g., 48 Hz to 52 Hz, in which the health indicator is measured for that particular component.

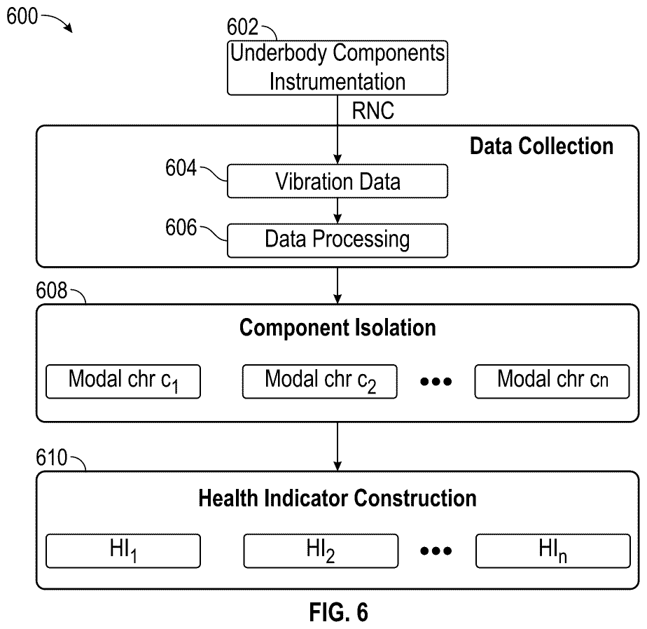

FIG. 6 illustrates a method 600 for determining health indication data for individual components of a multicomponent dynamic system according to an embodiment of the present disclosure. Method 600 may be performed on the vehicle as a whole or at the multicomponent dynamic system level. At step 602, the multicomponent dynamic system or vehicle may be subjected to broadband excitation. Vibration data may be collected, e.g., using sensors such as road noise cancellation (RNC) sensors, at step 604. The vibration data is then processed at step 606 to determine the modal characteristics of each individual components of the multicomponent dynamic system using any one of the techniques described above (step 608). Based on the knowledge of the modal characteristics of each of the component, the frequency neighborhood for extracting health indication data for each component is determined (step 610). This knowledge of the frequency neighborhood for each component is then used to extract health indicator data of the components, such as in process 400 above.

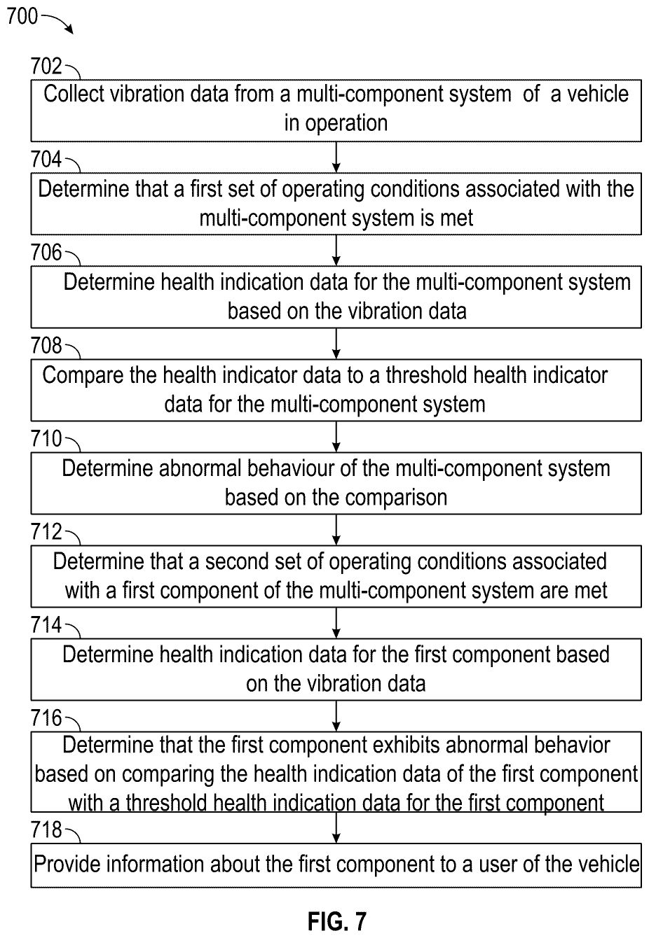

FIG. 7 illustrates a flow chart of a process 700 for determining health of a component in real-time according to an embodiment of the present disclosure. The process 700 may be performed, e.g., by the vehicle 100 of FIG. 1 and/or the server 200 of FIG. 2. When the vehicle is being operated, such as a user driving the vehicle on a road, one or more sensors coupled to the vehicle collect vibration data associated with one or more multicomponent dynamic systems of the vehicle (step 702). In an embodiment, the multicomponent dynamic system may be an underbody system such as a suspension system. The vibration data may be collected using one or more road noise cancellation sensors. At step 704, the vehicle may determine that a first set of operating conditions associated with the multicomponent dynamic system has been met. The first set of operating conditions may include a speed range, a steering angle range, tire pressure range, etc. Based on the determination that the first set of operating conditions has been met, the vehicle may then use the vibration data, collected during an interval when the first set of operating conditions are met, to determine health indication data for the multicomponent dynamic system at step 706. The vehicle may then use this health indication data of the multicomponent dynamic system and compare that with a threshold health indication data for the multicomponent dynamic (step 708). Based on the comparison, the vehicle may determine that the multicomponent dynamic system is exhibiting unexpected behavior (step 710). Once it is determined that the multicomponent dynamic system is exhibiting unexpected behavior, the next step is to determine which specific component or components of the multicomponent dynamic system is a contributor to the unexpected behavior of the multicomponent dynamic system.

At step 712, the vehicle may determine that a second set of operating conditions associated with a first component of the multicomponent dynamic system are satisfied. In an embodiment, the second set of operating conditions is a subset of the first set of operating conditions. Once it is determined that the second set of operating conditions are satisfied, the vehicle may then use the captured vibration data and the a priori knowledge of the frequency range associated with the local mode of the first component to determine health indication data for the first component (step 714). The health indication data of the first component is then compared with a threshold or reference health indication data of the first component to determine that the first component is exhibiting unexpected behavior (step 716). In an embodiment, steps 712, 714, and 716 may be performed for multiple components of the multicomponent dynamic system based if the set of operating conditions associated with those components are satisfied. Once it is determined that the first component (and any other components) is exhibiting unexpected behavior based on is modal characteristics, the vehicle may provide information about that component, at step 718. In an embodiment, one or more of a part number, a description, a location or a serial number of the first component may be displayed on the vehicle infotainment system. In another embodiment, an audio output identifying the first component may be played via the vehicle's speakers. In yet another embodiment, the information about the first component may be sent to a user device. In an embodiment, the vehicle may store the information about the first component in the ECU and merely display an alert to the user to get the vehicle checked. A service personnel may then extract that information from the ECU, e.g., via the OBD port of the vehicle. Once the user of the vehicle receives the information about the first component, he/she can then provide that information to a service personnel. This will help the service personnel in quickly diagnosing and fixing the issue.

It is to be noted that the vehicle implements and/or performs operations, as described here in the present disclosure, in accordance with the owner manual and safety guidelines. In addition, any action taken by the vehicle owner based on recommendations or notifications provided by the vehicle should comply with all the rules specific to the location and operation of the vehicle (e.g., Federal, state, country, city, etc.). The recommendation or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving, by a vehicle, vibration data associated with a multicomponent system of the vehicle;
determining, by the vehicle, that a first set of operating conditions associated with the multicomponent system have been satisfied;
determining, by the vehicle and based on the vibration data, first health indication data associated with the multicomponent system;
determining, by the vehicle and based on the first health indication data, that the multicomponent system is exhibiting unexpected behavior;
determining, by the vehicle, that a second set of operating conditions associated with a first component of the multicomponent system have been satisfied;
determining, by the vehicle and based on the vibration data, second health indication data associated with the first component;
determining, by the vehicle and based on the second health indication data, that the first component is exhibiting unexpected behavior; and
outputting, by the vehicle, information about the first component.

2. The method of claim 1, wherein receiving the vibration data comprises receiving the vibration data from one or more acceleration sensors coupled to the vehicle.

3. The method of claim 1, wherein the second set of operating conditions is a subset of the first set of operating conditions.

4. The method of claim 1, wherein the first health indication data includes global data associated with the multicomponent system.

5. The method of claim 1, wherein outputting the information about the first component comprises outputting a visual or audible output.

6. The method of claim 1, wherein determining that the first component is exhibiting unexpected behavior further comprises comparing the second health indication data with threshold health indication data associated with the first component.

7. The method of claim 1, wherein the second health indication data includes local mode data associated with the first component.

8. The method of claim 1, wherein the first set of operating conditions include one or more of: a vehicle speed, a vehicle acceleration, a steering angle associated with the vehicle, tire pressure associated with the vehicle, ambient temperature of an environment in which the vehicle is operating, gross train weight of the vehicle, or brake torque associated with the vehicle.

9. A vehicle comprising:
one or more processors;
one or more memories coupled to the one or more processors;
a communication interface coupled to the one or more processors; and
one or more sensors coupled to the one or more processors,
wherein the one or more memories store instructions, which when executed by the one or more processors cause the one or more processors to:
receive, from the one or more sensors, vibration data associated with a multicomponent system of the vehicle;
determine that a first set of operating conditions associated with the multicomponent system have been satisfied;
determine, responsive to the first set of operating conditions being satisfied, first health indication data associated with the multicomponent system;
determine, based on the first health indication data, that the multicomponent system is exhibiting unexpected behavior;
determine that a second set of operating conditions associated with a first component of the multicomponent system have been satisfied;
determine, responsive to the second set of operating conditions being satisfied and based on the vibration data, second health indication data associated with the first component;
determine, based on the second health indication data, that the first component is exhibiting unexpected behavior; and
output information about the first component.

10. The vehicle of claim 9, wherein the one or more sensors include accelerometers.

11. The vehicle of claim 9, wherein the second set of operating conditions is a subset of the first set of operating conditions.

12. The vehicle of claim 9, wherein the first health indication data includes global data associated with the multicomponent system.

13. The vehicle of claim 9, wherein the second health indication data includes local mode data associated with the first component.

14. The vehicle of claim 9, wherein the first set of operating conditions include one or more of: a vehicle speed, a vehicle acceleration, a steering angle associated with the vehicle, tire pressure associated with the vehicle, ambient temperature of an environment in which the vehicle is operating, gross train weight of the vehicle, or brake torque associated with the vehicle.

15. The vehicle of claim 9, wherein to determine that the first component is exhibiting unexpected behavior, the one or more processors compare the second health indication data with threshold health indication data associated with the first component.

16. A vehicle comprising:
one or more processors;
one or more sensors coupled to the one or more processors; and
a system having a plurality of mechanical components,
wherein the one or more processors are configured to:
receive, from the one or more sensors, vibration data associated with the system;
determine that a first set of operating conditions associated with the system are satisfied;
determine first health indication data associated with the system, wherein the first health indication data is based on global data associated with the system;
determine, based on the first health indication data, that the system is exhibiting unexpected behavior;
responsive to determining that the system is exhibiting unexpected behavior, determine that a second set of operating conditions associated with a first component of the plurality of components are satisfied;
determine second health indication data associated with the first component;
determine, based on the second health indication data, that the first component is exhibiting unexpected behavior; and
output information about the first component.

17. The vehicle of claim 16, wherein the information about the first component includes one or more of: remaining useful life estimation of the component, a part number associated with the first component, a description of the first component, a location of the first component, or a serial number of the first component.

18. The vehicle of claim 16, wherein the first health indication data and the second health indication data are determined using the vibration data.

19. The vehicle of claim 16, wherein the second health indication data is determined based on local mode data of the first component.

20. The vehicle of claim 16, wherein the system is an underbody system of the vehicle.
